(19) United States
(12) Patent Application Publication
(10) Pub. No.: US 2024/0017447 A1
(43) Pub. Date: Jan. 18, 2024

(54) WIND TURBINE BLADE MOLD STRUCTURE

(71) Applicant: GURIT TOOLING (TAICANG) CO., LTD., Suzhou (CN)

(72) Inventors: Kangsheng SHI, Suzhou (CN); Jialin LU, Suzhou (CN); Binjiang CHEN, Hacienda Heights, CA (US)

(21) Appl. No.: 18/338,132

(22) Filed: Jun. 20, 2023

Related U.S. Application Data
(63) Continuation of application No. PCT/CN2022/114164, filed on Aug. 23, 2022.

(30) Foreign Application Priority Data
Jul. 15, 2022 (CN) 202210830996.3
Jul. 15, 2022 (CN) 202221821127.6

(51) Int. Cl. B29C 33/30; B29C 33/26

(52) U.S. Cl. CPC B29C 33/306; B29C 33/26; B29L 2031/085

(57) ABSTRACT

A wind turbine blade mold structure includes reinforcing structures separately mounted on outer surfaces of a lower mold and an upper mold, and conformal support structures or support structures, each with one end fixed on the ground and the other end resisting the reinforcing structures; the conformal support structures or the support structures are adjustable in horizontal heights; the structure improves the flexural rigidity, thus greatly improving the anti-deformation capacity of a shell to simplify the support structures, accelerating the manufacturing and mounting process, reducing the dimensions of the structure, reducing the overall weight of a mechanism, facilitating the transportation, and reducing the energy consumption and pollution.

### CROSS-REFERENCE TO RELATED APPLICATIONS

This application is the Continuation Application of International Application No. PCT/CN2022/114164 filed on 23 Aug. 2022 which designated the U.S. and claims priority to Chinese Application Nos. CN202210830996.3 and CN202221821127.6 filed on 15 Jul. 2022, the entire contents of each of which are hereby incorporated by reference.

### TECHNICAL FIELD

The present invention relates to the field of wind turbine blade molds, and specifically to a novel wind turbine blade mold structure.

### BACKGROUND

Wind is a natural phenomenon on the earth, which is caused by solar radiant heat. The sunlight irradiates the earth surface, and different parts on the earth surface are heated differently to generate a temperature difference, thus causing atmospheric convection to form wind. Wind energy is kinetic energy of air. The magnitude of the wind energy is determined by wind speed and density of the air. The global wind energy is about 2.74×10⁹ MW, including available wind energy of 2×10⁷ MW, which is 10 times the total volume of available hydroenergy on the earth. The kinetic energy of air flow is wind energy. Wind energy is a form converted from solar energy. The radiation of the sun causes non-uniform heating of the earth surface, which causes non-uniform pressure distribution in the atmosphere, and thus air motion along a horizontal direction to form wind.

Wind energy is a kind of available energy provided to human beings by air flow doing work, and is a renewable energy. The kinetic energy of the air flow is wind energy. A higher air flow rate indicates higher kinetic energy. The kinetic energy of wind can be converted into a rotary motion using a windmill to drive a power generator to generate electricity through transmitting the rotating power of a rotor to the power generator via a transmission shaft.

The cost of using wind to generate electricity has decreased considerably. Even without additional external costs, the cost of using wind power generation in many suitable locations has been less than that of diesel generators. With the development of carbon neutrality and peak carbon dioxide emission in the world, clean energy becomes a unified direction of global vigorous development, such that the wind power, as one of the clean energies, also rises and develops rapidly throughout the world.

Wind turbines are used for continuously converting wind energy into standard municipal electricity for houses, which obviously saves resources. A street lamp using free energy all the year round can be made by virtue of the wind turbine in a mountainous area. A night road sign lamp can be made from the wind turbine on an expressway. Children in mountain areas can study at night under fluorescent lamps. The wind turbine can also be used on the roof of small and high-rise buildings in the urban regions, which not only saves energy, but is also a real green power supply. A household wind turbine not only prevents power failure, but also increases life interest. In tourist attractions, border defenses, schools, troops and even backward mountainous areas, wind turbines is becoming a hot spot for people to purchase. Radio aficionados can use their own skills to serve people living in mountainous areas in the aspect of wind power generation, so that people living in mountainous areas can watch televisions and use electricity for lighting just like people living in cities. The radio aficionados can live a good life by such techniques. Therefore, the wind power market is prosperous, and wind turbine blade manufacturers also manufacture blades overtime to meet the requirements of the large market. In order to fast and efficiently manufacture wind turbine blades with high quality, various new techniques and fixtures also emerge for meeting the requirements of the wind turbine blade manufactures.

In the prior art, a typical wind turbine blade mold is composed of a composite material mold shell (101), support structures (201, 202) of the shell, an action mechanism 401 and other accessory structures, as shown in FIG. 1. Glass fiber reinforced plastic shells of the mold mainly provides an overall dimension for blade manufacturing and other process conditions such as vacuum, temperature and the like. The glass fiber reinforced plastic shell usually has a thickness of 10 mm to 60 mm. The glass fiber reinforced plastic shell is provided with a bottom framework support which is usually of a spatial structure formed by welding structural steel. The bottom framework support is integrated with the mold shell to maintain the accuracy of the geometric dimensions of the mold shell in the blade manufacturing process. Common action mechanisms include traveling cranes or turnover arms which are arranged at a certain interval along the length direction of the mold. They are used for driving the upper mold (302) to turn over in processes of closing and opening the two molds (301, 302). A typical blade mold is shown in FIG. 1. For a mold using turnover arms, the upper mold steel frame supports (202) are on the turnover arms, and the turnover arms are mounted on the ground. Thus, the turnover arms also serve as pivots to support the upper mold when the upper mold is in an opening state. A typical mold turnover action is shown in FIG. 2.

Since the blades have different lengths and shapes, steel frames of a mold manufactured for a wind turbine blade is designated for the dimensions of the wind turbine blade in view of that a ground projection area of the steel frame structure is basically equal to that of the blade. A typical steel frame support structure is shown in FIG. 3. The glass fiber reinforced plastic shell of the wind turbine blade mold is relatively low in rigidity. In order to maintain the profile accuracy of the shell, dense support structures are needed, resulting in complicated structures and difficulties in design and manufacturing. Moreover, the corresponding mold will be abandoned if this kind of blades are no longer produced, and the steel frames cannot be used on other molds and can only be disposed as waste steel. The production cycle of each kind of blades is about 2 years at present, and about tens of tons of steel will be used for each set of mold, leading to a considerable waste.

### SUMMARY

Objective: The present utility model is intended to solve the shortcomings in the prior art by providing a wind turbine blade mold structure which improves the flexural rigidity, thus greatly improving the anti-deformation capacity of a shell to simplify the support structures, accelerating the manufacturing and mounting, reducing the dimensions of the structure, reducing the overall weight of a mechanism, facilitating the transportation, reducing the energy consumption and pollution, improving the mounting efficiency and saving the cost.

Technical scheme: In order to achieve the above objective, a wind turbine blade mold structure is provided, comprising a lower mold; an upper mold; a lower mold shell support structure and an upper mold shell support structure located on inner surfaces of the lower mold and the upper mold, respectively; a turnover mechanism configured for driving the upper mold shell support structure to turn over above the lower mold shell support structure; reinforcing structures separately mounted on outer surfaces of the lower mold and the upper mold; and conformal support structures or support structures, each with one end fixed on the ground and the other end resisting the reinforcing structures, wherein the conformal support structures or the support structures are adjustable in horizontal heights; the conformal support structures or the support structures can be combined arbitrarily according to shapes of the reinforcing structures, featuring high flexibility. Adaptation to different kinds of blades only requires a replacement of the shell structure and adjustment of the horizontal heights of the conformal support structures or support structures to adapt to molds of different blades, thus achieving reuse, improving the mounting efficiency and saving the cost.

Each of the reinforcing structures is a reinforcing rib structure, a box structure, a sandwich structure made of a low-density material, a frame structure, or a combined structure of two or more of the above structures. The reinforcing rib structure, the box structure and the frame structure of the reinforcing structures are made of a metal material or a composite material or a combination of the metal material and the composite material. Thus, the flexural rigidity of the enhanced glass fiber reinforced plastic mold shell structure is greater than that of a common mold shell by several orders of magnitude, so that the anti-deformation capacity of the shell is greatly improved, providing necessary conditions for fewer and simpler support structures.

In a further preferred embodiment of the present utility model, when each of the reinforcing structures has a curved surface, the reinforcing structure is resisted by the conformal support structure; when the wind turbine blade mold needs to be opened to a certain angle, the upper mold or the lower mold is supported by the conformal support structures, which ensure an environment for manufacturing a boundary dimension of the blade and other process conditions.

In a further preferred embodiment of the present utility model, when each of the reinforcing structures has a planar surface, the reinforcing structure is resisted by the conformal support structure or the support structure.

The conformal support structures or the support structures are combined arbitrarily according to shapes of the reinforcing structures. There are various implementations for the support structures. Any implementation can be combined with the conformal support structures.

When the reinforcing structure on the lower mold has a planar surface, and the reinforcing structure on the upper mold has a curved surface, the reinforcing structure on the lower mold is resisted by the conformal support structure or the support structure, and the reinforcing structure on the upper mold is resisted by the conformal support structure.

When the reinforcing structure on the lower mold has a curved surface, and the reinforcing structure on the upper mold has a planar surface, the reinforcing structure on the lower mold is resisted by the conformal support structure, and the reinforcing structure on the upper mold is resisted by the conformal support structure or the support structure.

When the reinforcing structures on both the upper mold and the lower mold have planar surfaces, the reinforcing structures on the lower mold and the upper mold are resisted by the conformal support structure or the support structure.

When the reinforcing structures on both the upper mold and the lower mold have curved surfaces, the reinforcing structures on the upper mold and the lower mold are resisted by the conformal support structure.

In a further preferred embodiment of the present utility model, each of the conformal support structures comprises a base and an underframe for placing a PLC, and a telescopic cylinder connected to the PLC; the underframe is mounted above the base; a plurality of telescopic cylinders connected to the PLC are arranged on the underframe. When each of the reinforcing structures has a curved surface, since the parts are not on the same horizontal level, different positions need to be supported at different heights. Therefore, the PLC calculates an extending height of each telescopic cylinder according to the shapes of the curved surfaces of the reinforcing structures, the upper mold is turned to a limit position through the turnover mechanism, and the conformal support structures can support the upper mold.

The base may be the ground or a support plate. If the underframe is suitable for placing on the ground, no support plate is required. If the ground is not suitable for settling the underframe, the base should be added to cooperate with the underframe.

In a further preferred embodiment of the present utility model, the telescopic cylinders is powered by a servo motor, a hydraulic system or a pneumatic system. The servo motor, the hydraulic system or the pneumatic system cooperates with the PLC, such that the conformal support structures are more flexible in application scenarios; automatic control can reduce the loss of materials, shorten the assembling time, and improve the working efficiency.

In a further preferred embodiment of the present utility model, the number of underframes is more than one, and is determined by size of the lower mold or the upper mold.

In a further preferred embodiment of the present utility model, a length between two adjacent underframes is L, and a deformation of a mold shell in the lower mold or the upper mold is m. The number and placement positions of the underframes are determined according to weight distributions of the blade and the mold to ensure effective supporting. The effective support is mainly dependent on the deformation m of the shell within the length L between two support sections along a length direction of the mold, and the relationship is m<L/300.

In a further preferred embodiment of the present utility model, the support structure is formed by arranging and combining a plurality of steel frames, steel pipes or support rods with different lengths fixed on the ground. When the planar reinforcing structures need to be supported, heights of the steel frames, the steel pipes or the support rods having different lengths at different positions are manually calculated according to a size where the lower mold or the upper mold that is required to be opened; then the heights of the steel frames, the steel pipes or the support rods with different lengths are increased or decreased, and the steel frames, the steel pipes or the support rods with different lengths are then fixed on the ground.

In a further preferred embodiment of the present utility model, the arranged and combined steel frames, steel pipes or support rods with different lengths increase or decrease the heights of the support structures by means of corner joint, snap fit, threaded connection, and the like.

In a further preferred embodiment of the present utility model, the low-density material is prepared by combining artificial foam, a low-density inorganic material, a low-density wood and a honeycomb material. A spatial thickness of the reinforcing structure obtained by this preparation method may vary from 60 mm to 2 m, leading to more flexible application scenarios and a wider application range.

Beneficial effects: Compared with the prior art, the wind turbine blade mold structure of the present utility model has the following advantages:
a. the flexural rigidity of the enhanced glass fiber reinforced plastic mold shell structure is greater than that of a common mold shell by several orders of magnitude, so that the anti-deformation capacity of the shell is greatly improved, providing necessary conditions for fewer and simpler support structures.
b. compared with an original framework structure, the simplified mold structure made of universal support structures can save 60%-80% of the materials, greatly accelerating the manufacturing process and reducing the energy consumption and pollution.
c. use of the shell and the universal support structures reduces and simplifies the mounting process, accelerates the mounting process, and effectively improves the mounting efficiency.
d. by means of adjusting the horizontal heights of the conformal support structures or the support structures, the wind turbine blade mold structure adapts to mold structures of different kinds of blades. During replacement of a blade, only the upper layer structure of the mold is replaced, and the heights of the conformal support structures or the support structures in the lower layer are adjusted, so that waste and pollution are greatly reduced, and the cost is saved, providing a better solution for sustainable development of economy and environment.
e. if part of support components of the support structures or the conformal support structures need to be replaced due to a fatigue limit, only the modules or the components are replaced, so that the flexibility is high. Accessories can be produced in batches, which improves the working efficiency of turnover of the mold, shortens the repair time, and increases the adaptability.

### BRIEF DESCRIPTION OF THE DRAWINGS

FIG. 1 is a schematic diagram of a blade mold structure in the prior art;

FIG. 2 is a schematic diagram of a turnover action of a mold in the prior art;

FIG. 3 is a schematic structural diagram of a steel frame support structure in the prior art;

FIG. 4 is a schematic structural diagram of the conformal support structure;

FIG. 5 is a schematic structural diagram of another support structure;

FIG. 6 is a schematic diagram for mounting the support structure;

FIG. 7 is a schematic diagram of the turnover action of the mold in the present utility model;

FIG. 8 is a schematic diagram for mounting of the another support structure;

FIG. 9 is a schematic diagram for mounting of the another support structure;

FIG. 10 is a reinforcing structure of the reinforcing rib structure;

FIG. 11 is a reinforcing structure of the sandwich structure;

FIG. 12 is a reinforcing structure of the box structure;

FIG. 13 is a reinforcing structure of the frame structure;

FIG. 14 is a hydraulic circuit diagram of the telescopic cylinder.

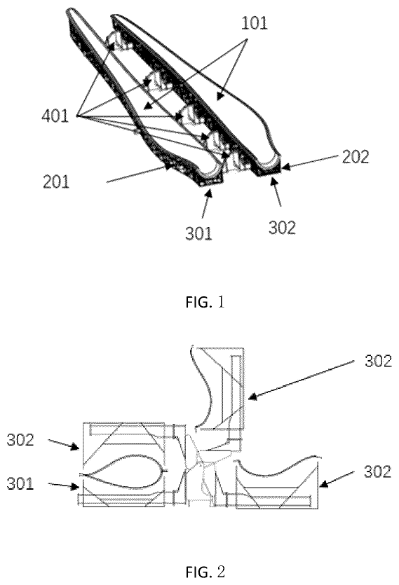

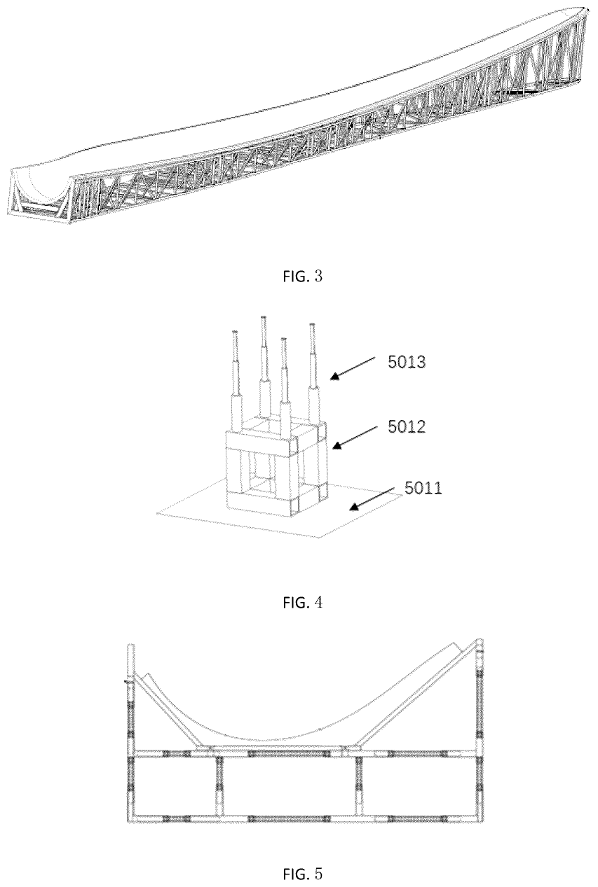

### DETAILED DESCRIPTION

The present utility model will be further described below with reference to the drawings and examples.

A wind turbine blade mold structure is provided, comprising a lower mold 301, an upper mold 302, a lower mold shell support structure 201, an upper mold shell support structure 202, a turnover mechanism 401, reinforcing structures (102) separately mounted on outer surfaces of the lower mold 301 and the upper mold 302, and conformal support structures 501 or support structures 502 each with one end fixed on the ground and the other end resisting the reinforcing structures 102, wherein the conformal support structures 501 or the support structures 502 are adjustable in horizontal heights.

The reinforcing structures 102 is of an interior reinforcing rib structure, frame structure, box structure or sandwich structure consisting of an artificial foam, a low-density inorganic material, a low-density wood and a honeycomb material.

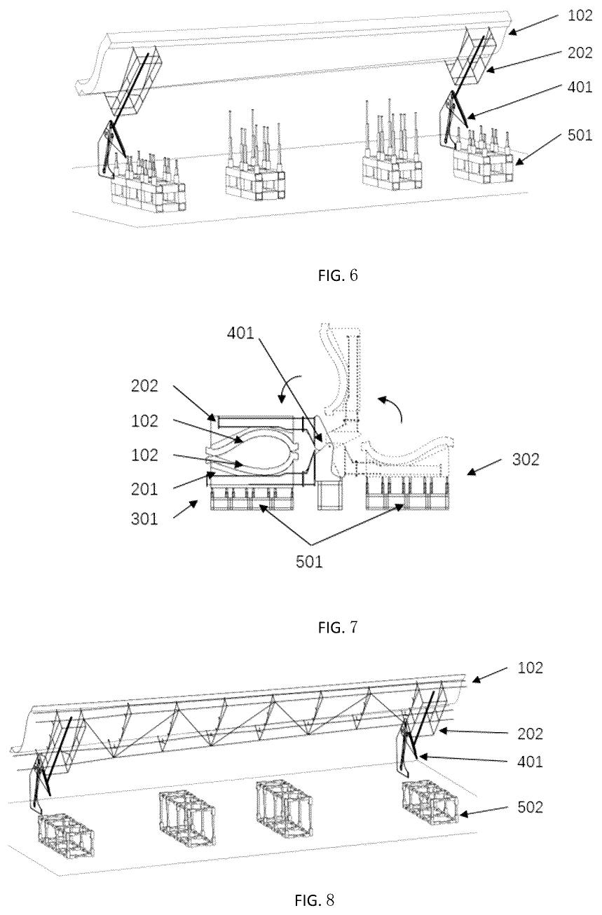

Each of the conformal support structures 501 comprises a base 5011 and an underframe 5012 for placing a PLC, and a telescopic cylinder 5013 connected to the PLC; the underframe 5012 is mounted above the base 5011; a plurality of telescopic cylinders 5013 connected to the PLC are arranged on the underframe 5012, as shown in FIG. 4 and FIG. 6. When the conformal support structure can be directly fixed on the ground, the telescopic cylinders 5013 connected to the PLC can also be directly used, as shown in FIG. 9.

The upper mold shell support structure 202 is driven by the turnover mechanism 401 to separate from the conformal support structures 501 or the support structures 502 and turn over, and then resists the lower mold 301 to achieve a closing effect, as shown in FIG. 7.

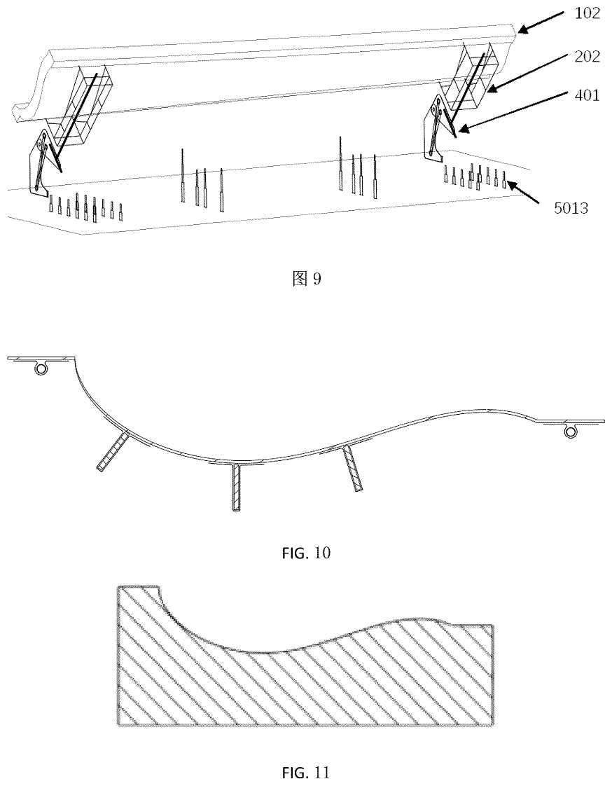

The support structure 502 is formed by arranging and combining a plurality of steel frames or steel pipes fixed on the ground, as shown in FIG. 8. When switching to a reinforcing structure 102 with a different shape, the conformal support structures 501 and the support structures 502 can be recycled for multiple times, thus reducing the cost.

### Example 1

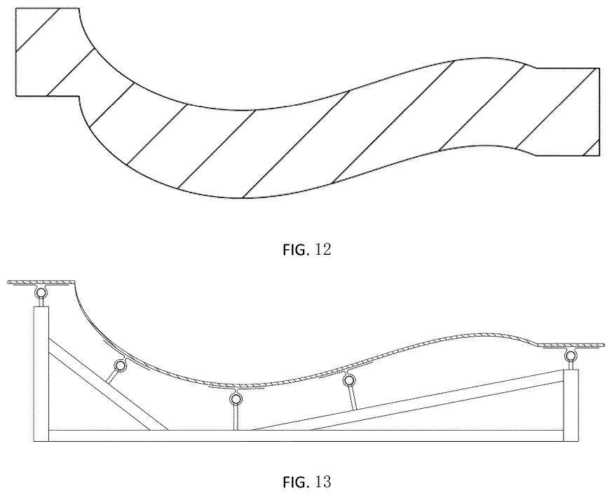

When the reinforcing structure 102 on the lower mold 301 has a planar surface, and the reinforcing structure 102 on the upper mold 302 has a curved surface, the reinforcing structure 102 on the lower mold 301 is resisted by the support structure 502, and the reinforcing structure 102 on the upper mold 302 is resisted by the conformal support structure 501. The reinforcing structure 102 of a lower mold shell adopts a reinforcing rib structure or sandwich structure, as shown in FIG. 10 and FIG. 11. The reinforcing structure 102 of an upper mold shell adopts a box structure or a frame structure, as shown in FIG. 12 and FIG. 13. At a turnover beam, the turnover mechanism 401 is connected and fixed to the reinforcing structures 102 through the lower mold shell support structure 201 or the upper mold shell support structure 202. A plurality of conformal support structures 501 are arranged between two adjacent turnover mechanisms 401. Effective supporting is achieved by decreasing or increasing the number of the underframes 5012, and extending and retracting heights of the telescopic cylinders are adjusted to fit the shape of the shell, as shown in FIG. 4 and FIG. 6.

Since the reinforcing structure 102 on the upper mold 302 has a curved surface, the parts to be supported are not on the same horizontal level, and thus the parts at different positions need to be supported at different heights. As such, the PLC calculates an extending height of each of the telescopic cylinders 5013 according to the shape of the curved surface of the reinforcing structure 102. The conformal support structures 501 support the upper mold 302. The upper mold 302 is turned to a limit position through the turnover mechanism 401.

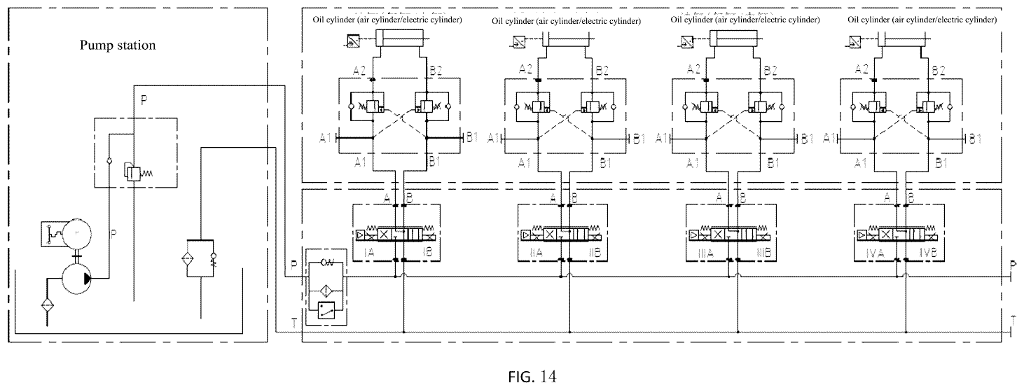

A distance sensor is arranged on a side surface of an end of the telescopic cylinder 5013. After the PLC sends a signal to the hydraulic system to enable a piston rod on the telescopic cylinder 5013 to extend to a limit position, when the distance sensor senses that the reinforcing structure 102 is not in contact with the piston rod, the distance sensor sends the signal to the PLC, and the PLC recalculates an extending height of the telescopic cylinder 5013 according to a received distance of the distance sensor and compensates an extending or retracting distance to ensure the support stability. A hydraulic circuit of each of the conformal support structures 501 is shown in FIG. 14.

Since the reinforcing structure 102 on the lower mold 301 has a planar surface, the support structure 502 is formed by arranging and combining a plurality of steel frames fixed on the ground. When the planar reinforcing structure 102 needs to be supported, a height of the steel frames used for supporting the upper mold 302 or the lower mold 301 is manually calculated according to the height of the lower mold 301 or an opening size of the upper mold 302, and the height of the steel frame or steel pipe is increased or decreased by means of adjustment of threaded connection, corner joint, snap fit and the like, as shown in FIG. 8.

When switching to a different blade, that is, when the reinforcing structure 102 with a different shape is to be used, the original reinforcing structures 102 can be removed, and a reinforcing structure 102 fitting the shape of the outer surface of the lower mold 301 or the upper mold 302 is mounted; and the conformal support structures 501 and the support structures 502 are adjusted to fit the new reinforcing structure 102. The conformal support structures 501 and the support structures 502 are highly adaptable and can be reused for multiple times, thus reducing the cost and improving the working efficiency.

### Example 2

When the reinforcing structure 102 on the lower mold 301 and the reinforcing structure 102 on the upper mold 302 have curved surfaces, the reinforcing structure 102 on the lower mold 301 and the reinforcing structure 102 on the upper mold 302 are resisted by the conformal support structures 501. The reinforcing structure 102 of a lower mold shell and the reinforcing structure 102 of an upper mold shell both adopt a combination of a reinforcing rib structure and sandwich structure, as shown in FIG. 10 and FIG. 11. At a turnover beam, the turnover mechanism 401 is connected and fixed to the reinforcing structures 102 through the lower mold shell support structure 201 or the upper mold shell support structure 202. A plurality of support structures 502 are arranged between two adjacent turnover mechanisms 401. Effective supporting is achieved by decreasing or increasing the number of the underframes 5012, and extending and retracting heights of the telescopic cylinders are adjusted to fit the shape of the shell, as shown in FIG. 4 and FIG. 6.

Since both the reinforcing structure 102 on the lower mold 301 and the reinforcing structure 102 on the upper mold 302 have curved bottom surfaces, the parts to be supported are not on the same horizontal level, and thus the parts at different positions need to be supported at different heights. As such, the PLC calculates an extending height of each of the telescopic cylinders 5013 according to the shape of the curved surface of the reinforcing structure 102. The conformal support structures 501 support the upper mold 302. The upper mold 302 is turned to a limit position through the turnover mechanism 401.

A distance sensor is arranged on a side surface of an end of the telescopic cylinder 5013. After the PLC sends a signal to the hydraulic system to enable a piston rod on the telescopic cylinder 5013 to extend to a limit position, when the distance sensor senses that the reinforcing structure 102 is not in contact with the piston rod, the distance sensor sends the signal to the PLC, and the PLC recalculates an extending height of the telescopic cylinder 5013 according to a received distance of the distance sensor and compensates an extending or retracting distance to ensure the support stability. A hydraulic circuit of each of the conformal support structures 501 is shown in FIG. 14.

When switching to a different blade, that is, when the reinforcing structure 102 with a different shape is to be used, the original reinforcing structures 102 can be removed, and a reinforcing structure 102 fitting the shape of the outer surface of the lower mold 301 or the upper mold 302 is mounted; and the conformal support structures 501 and the support structures 502 are adjusted to fit the new reinforcing structure 102. The conformal support structures 501 and the support structures 502 are highly adaptable and can be reused for multiple times, thus reducing the cost and improving the working efficiency.

### Example 3

When the reinforcing structure 102 on the lower mold 301 has a curved surface, and the reinforcing structure 102 on the upper mold 302 has a planar surface, the reinforcing structure 102 on the lower mold 301 is resisted by the conformal support structure 501, and the reinforcing structure 102 on the upper mold 302 is resisted by the support structure 502. The reinforcing structure 102 of a lower mold shell adopts a reinforcing rib structure or sandwich structure, as shown in FIG. 10 and FIG. 11. The reinforcing structure 102 of an upper mold shell adopts a box structure or a frame structure, as shown in FIG. 12 and FIG. 13. At a turnover beam, the turnover mechanism 401 is connected and fixed to the reinforcing structures 102 through the lower mold shell support structure 201 or the upper mold shell support structure 202. A plurality of support structures 502 are arranged between two adjacent turnover mechanisms 401.

Since the reinforcing structure 102 on the lower mold 301 has a curved surface, the parts to be supported are not on the same horizontal level, and thus the parts at different positions need to be supported at different heights. As such, the PLC calculates an extending height of each of the telescopic cylinders 5013 according to the shape of the curved surface of the reinforcing structure 102. The conformal support structures 501 support the upper mold 302. The upper mold 302 is turned to a limit position through the turnover mechanism 401.

A distance sensor is arranged on a side surface of an end of the telescopic cylinder 5013. After the PLC sends a signal to the hydraulic system to enable a piston rod on the telescopic cylinder 5013 to extend to a limit position, when the distance sensor senses that the reinforcing structure 102 is not in contact with the piston rod, the distance sensor sends the signal to the PLC, and the PLC recalculates an extending height of the telescopic cylinder 5013 according to a received distance of the distance sensor and compensates an extending or retracting distance to ensure the support stability. A hydraulic circuit of each of the conformal support structures 501 is shown in FIG. 13.

Since the reinforcing structure 102 on the upper mold 301 has a planar surface, the support structure 502 is formed by arranging and combining a plurality of steel pipes fixed on the ground, as shown in FIG. 5. When the planar reinforcing structure 102 needs to be supported, a height of the steel pipes used for supporting the upper mold 302 or the lower mold 301 is manually calculated according to the height of the lower mold 301 or an opening size of the upper mold 302, and the height of the steel frame or steel pipe is increased or decreased by means of adjustment of threaded connection, corner joint, snap fit and the like.

When switching to a different blade, that is, when the reinforcing structure 102 with a different shape is to be used, the original reinforcing structures 102 can be removed, and a reinforcing structure 102 fitting the shape of the outer surface of the lower mold 301 or the upper mold 302 is mounted; and the conformal support structures 501 and the support structures 502 are adjusted to fit the new reinforcing structure 102. The conformal support structures 501 and the support structures 502 are highly adaptable and can be reused for multiple times, thus reducing the cost and improving the working efficiency.

### Example 4

When the reinforcing structure 102 on the lower mold 301 and the reinforcing structure 102 on the upper mold 302 have planar surfaces, the lower mold 301 and the upper mold 302 are resisted by the support structures 502. The reinforcing structure 102 of a lower mold shell and the reinforcing structure 102 of an upper mold shell both adopt a box structure or a frame structure, as shown in FIG. 12 and FIG. 13. At a turnover beam, the turnover mechanism 401 is connected and fixed to the reinforcing structures 102 through the lower mold shell support structure 201 or the upper mold shell support structure 202. A plurality of support structures 502 are arranged between two adjacent turnover mechanisms 401.

Since both the reinforcing structure 102 on the lower mold 301 and the reinforcing structure 102 on the upper mold 302 have planar surfaces, the support structure 502 on the upper mold 302 is formed by arranging and combining a plurality of support rods with different lengths fixed on the ground, as shown in FIG. 8. When the planar reinforcing structure 102 on the lower mold 301 needs to be supported, a height of the steel frames used for supporting the upper mold 302 or the lower mold 301 is manually calculated according to the height of the lower mold 301 or an opening size of the upper mold 302, and the positions of the support rods are adjusted according to different heights, as shown in FIG. 8.

When switching to a different blade, that is, when the reinforcing structure 102 with a different shape is to be used, the original reinforcing structures 102 can be removed, and a reinforcing structure 102 fitting the shape of the outer surface of the lower mold 301 or the upper mold 302 is mounted; and the conformal support structures 501 and the support structures 502 are adjusted to fit the new reinforcing structure 102. The conformal support structures 501 and the support structures 502 are highly adaptable and can be reused for multiple times, thus reducing the cost and improving the working efficiency.

### Example 5

When the reinforcing structure 102 on the lower mold 301 and the reinforcing structure 102 on the upper mold 302 have curved surfaces, the lower mold 301 and the upper mold 302 are both resisted by the conformal support structure 501. The reinforcing structure 102 of a lower mold shell and the reinforcing structure 102 of an upper mold shell both adopt a box structure or a frame structure, as shown in FIG. 12 and FIG. 13. At a turnover beam, the turnover mechanism 401 is connected and fixed to the reinforcing structures 102 through the lower mold shell support structure 201 or the upper mold shell support structure 202. A plurality of conformal support structures 501 are arranged between two adjacent turnover mechanisms 401. Effective supporting is achieved by decreasing or increasing the number of the underframes 5012 the extending and retracting heights of the telescopic cylinders are adjusted to fit the bottom surface of the reinforcing structure 102.

The PLC calculates an extending height of each of the telescopic cylinders 5013 according to the bottom surface condition of the reinforcing structure 102. The corresponding conformal support structures 501 support the upper mold 302 and the lower mold 301, respectively. The upper mold 302 is turned to a limit position through the turnover mechanism 401.

A distance sensor is arranged on a side surface of an end of the telescopic cylinder 5013. After the PLC sends a signal to the hydraulic system to enable a piston rod on the telescopic cylinder 5013 to extend to a limit position, when the distance sensor senses that the reinforcing structure 102 is not in contact with the piston rod, the distance sensor sends the signal to the PLC, and the PLC recalculates an extending height of the telescopic cylinder 5013 according to a received distance of the distance sensor and compensates an extending or retracting distance to ensure the support stability. A hydraulic circuit of each of the conformal support structures 501 is shown in FIG. 13.

When switching to a different blade, that is, when the reinforcing structure 102 with a different shape is to be used, the original reinforcing structures 102 can be removed, and a reinforcing structure 102 fitting the shape of the outer surface of the lower mold 301 or the upper mold 302 is mounted; and the conformal support structures 501 and the support structures 502 are adjusted to fit the new reinforcing structure 102. The conformal support structures 501 and the support structures 502 are highly adaptable and can be reused for multiple times, thus reducing the cost and improving the working efficiency.

The above embodiments are intended only to illustrate the technical concept and features of the present utility model and to enable those skilled in the art to understand the contents of the present utility model and to implement the present utility model, but not to limit the protection scope of the present utility model. All equivalent changes and modifications made according to the spirit of the present utility model shall fall within the protection scope of the present utility model.

What is claimed is:

1. A wind turbine blade mold structure, comprising a lower mold (301); an upper mold (302); a lower mold shell support structure (201) and an upper mold shell support structure (202) located on inner surfaces of the lower mold (301) and the upper mold (302), respectively; a turnover mechanism (401) configured for driving the upper mold shell support structure (202) to turn over above the lower mold shell support structure (201); reinforcing structures (102) separately mounted on outer surfaces of the lower mold (301) and the upper mold (302); and conformal support structures (501) or support structures (502), each with one end detachably mounted on the ground and the other end resisting the reinforcing structures (102), wherein the conformal support structures (501) or the support structures (502) are adjustable in horizontal heights;
the conformal support structures (501) or the support structures (502) are combined arbitrarily according to shapes of the reinforcing structures (102);
each of the reinforcing structures (102) is a reinforcing rib structure, a box structure, a sandwich structure made of a low-density material, a frame structure, or a combined structure of two or more of the above structures.

2. The wind turbine blade mold structure according to claim 1, wherein when each of the reinforcing structures (102) has a curved surface, the reinforcing structure (102) is resisted by the conformal support structure (501).

3. The wind turbine blade mold structure according to claim 1, wherein when each of the reinforcing structures (102) has a planar surface, the reinforcing structure (102) is resisted by the conformal support structure (501) or the support structure (502).

4. The wind turbine blade mold structure according to claim 2, wherein each of the conformal support structures (501) comprises a base (5011) and an underframe (5012) for placing a programmable logic circuit (PLC), and a telescopic cylinder (5013) connected to the PLC; the underframe (5012) is mounted above the base (5011); a plurality of telescopic cylinders (5013) connected to the PLC are arranged on the underframe (5012).

5. The wind turbine blade mold structure according to claim 4, wherein the telescopic cylinders (5013) is powered by a servo motor, a hydraulic system or a pneumatic system.

6. The wind turbine blade mold structure according to claim 4, wherein the number of underframes (5012) is more than one, and is determined by size of the lower mold (301) or the upper mold (302).

7. The wind turbine blade mold structure according to claim 6, wherein a length between two adjacent underframes (5012) is L, and a deformation m of a mold shell in the lower mold (301) or the upper mold (302) is less than L/300.

8. The wind turbine blade mold structure according to claim 3, wherein the support structure (502) is formed by arranging and combining a plurality of steel frames, steel pipes or support rods with different lengths fixed on the ground.

9. The wind turbine blade mold structure according to claim 7, wherein the arranged and combined steel frames, steel pipes or support rods with different lengths increase or decrease the heights of the support structures (502) by means of corner joint, snap fit, or threaded connection.

10. The wind turbine blade mold structure according to claim 1, wherein the low-density material is prepared by combining artificial foam, a low-density inorganic material, a low-density wood and a honeycomb material.
